(19) United States
(12) Patent Application Publication
(10) Pub. No.: US 2012/0245258 A1
(43) Pub. Date: Sep. 27, 2012

(54) HIGHLY REACTIVE, STABILIZED ADHESIVE BASED ON POLYISOCYANATE

(75) Inventors: Hans-Ulrich Schmidt, Osnabrueck (DE); Waldemar Schatz, Muenster (DE); Stefan Ullmann, Germaringen (DE)

(73) Assignee: BASF SE, Ludwigshafen (DE)

(21) Appl. No.: 13/514,428

(22) PCT Filed: Dec. 8, 2010
(86) PCT No.: PCT/EP2010/069112

§ 371 Date: Jun. 7, 2012

(30) Foreign Application Priority Data
Dec. 8, 2009 (EP) 09178369.6

(51) Int. Cl. C08G 18/02; C08J 5/00; C08L 1/00

(52) U.S. Cl. 524/35; 528/59; 528/58; 264/331.11

(57) ABSTRACT

The present invention relates to a highly reactive isocyanate component comprising an organic isocyanate having at least two isocyanate groups, a catalyst based on an organic metal compound and a compound which comprises an aromatic sulfonyl isocyanate group. The present invention furthermore relates to a process for the production of lignocellulose-containing materials with the use of the highly reactive isocyanate component, such lignocellulose-containing materials and a sealant comprising the highly reactive isocyanate component.

The present invention relates to a highly reactive isocyanate component comprising an organic isocyanate having at least two isocyanate groups, a catalyst based on an organic metal compound and a compound which comprises an aromatic sulfonyl isocyanate group. The present invention furthermore relates to a process for the production of lignocellulose-containing materials with the use of the highly reactive isocyanate component, such lignocellulose-containing materials and a sealant comprising the highly reactive isocyanate component.

Materials based on lignocellulose are known. Important examples of lignocellulose-containing substances are wood parts, such as wood layers, wood strips, woodchips or wood fibers, it optionally also being possible for the wood fibers to originate from wood fiber-containing plants, such as flax, hemp, sunflowers, Jerusalem artichoke or rape. Starting materials for such wood parts or wood particles are usually timbers from the felling of forests, waste industrial timbers and used timbers and wood fiber-containing plants.

The treatment to give the desired lignocellulose-containing substances, such as wood particles, is effected by known processes, cf. for example M. Dunky, P. Niemt, Holzwerkstoffe and Leime, pages 91-156, Springer Verlag Heidelberg, 2002.

Lignocellulose-containing moldings, also referred to here as wood-based materials in the case of wood as lignocellulose, are an economical and resource-protecting alternative to solid wood and have become very important, in particular in furniture construction and as construction materials. As a rule, wood layers of different thickness, wood strips, woodchips or wood fibers from different woods serve as starting materials for wood-based materials. Such wood parts or wood particles are usually compressed at elevated temperature with natural and/or synthetic binders and optionally with addition of further additives to give board-like or strand-like wood-based materials. Examples of such lignocellulose-containing moldings or wood-based materials are medium density fiber boards (MDF), wood particle materials, such as particle boards and oriented strand boards (OSB), plywood, such as veneer plywood, and glued wood.

Binders used as a rule are formaldehyde-containing binders, for example urea-formaldehyde resins or melamine-containing urea-formaldehyde resins. The resins are prepared by polycondensation of formaldehyde with urea and/or melamine. The use of such formaldehyde resins can lead to the presence of free formaldehyde in the finished wood-based material. By hydrolysis of the polycondensates, additional formaldehyde can be liberated. The free formaldehyde in the wood-based material and the formaldehyde liberated during the life of the wood-based material by hydrolysis can be released to the environment.

Above certain limits, formaldehyde may cause allergies, skin irritation, irritation of the respiratory tract and eye irritation in humans. The reduction of formaldehyde emission in components, especially in the interior region, is therefore an important challenge.

For reducing or suppressing the formaldehyde emission, it is possible to use aminoplast glues which have been prepared using little formaldehyde. Furthermore, it is possible to aftertreat the finished wood-based materials with so-called formaldehyde scavengers, such as compounds comprising amine groups. A further possibility is the application of a top layer to the wood-based material, the top layer being obtained using a glue to which larger amounts of melamine and/or urea have been added as formaldehyde scavengers.

Such measures are, however, still not completely satisfactory. The preparation of the aminoplast glues using less formaldehyde or the addition of formaldehyde scavengers to the aminoplast glue results in the glue hardening more slowly, which prolongs the residence times in the hot press and hence adversely affects the cost-efficiency of the production of the wood-based material.

DE-A 2 306771 (Deutsche Novopan GmbH) describes a process for the production of particle boards from, for example, woodchips to which binder has been added and which are sprinkled in at least three layers and then hot-pressed, a defined phenol resin being used as a binder for the top layer and, for example, isocyanate being used as a binder in the middle layer.

DE 28 32 509 B1 (Deutsche Novopan GmbH) describes particle boards having a middle layer which was produced with urea-formaldehyde resin, isocyanate and addition of urea and a top layer which was produced with urea-formaldehyde resin and added urea.

Advantages of the use of isocyanate as a binder are the high hydrolysis stability of the lignocellulose-containing material obtained. A disadvantage of the use of isocyanates as binders is their relatively high price. The cost-efficiency of using isocyanates could be increased by shorter residence times in the hot press.

It was therefore an object of the present invention to provide an even more highly reactive isocyanate component which is suitable as a binder for the production of lignocellulose-containing materials, reacts rapidly during the hot pressing and nevertheless can be stored for a long time at room temperature.

The object according to the invention is achieved by a highly reactive isocyanate component comprising an organic isocyanate having at least two isocyanate groups, a catalyst based on an organic metal compound and a compound which comprises an aromatic sulfonyl isocyanate group.

All organic isocyanates and prepolymers known to the person skilled in the art, preferably those known for the production of wood-based materials or polyurethanes, can be used as organic isocyanate having at least two isocyanate groups. Such organic isocyanates and their preparation and use are described, for example, in Becker/Braun, Kunststoff Handbuch, 3rd revised addition, volume 7 “Polyurethane”, Hanser 1993, pages 17 to 21, pages 76 to 88 and pages 665 to 671.

Preferred organic isocyanates are oligomeric isocyanates having 2 to 10, preferably 2 to 8, monomer units and on average at least one isocyanate group per monomer unit.

A particularly preferred organic isocyanate is the oligomeric organic isocyanate PMDI (“polymeric methylenediphenylene diisocyanate”), which is obtainable by condensation of formaldehyde with aniline and phosgenation of the isomers and oligomers formed in the condensation (cf. for example Becker/Braun, Kunststoff Handbuch, 3rd revised edition, volume 7 “Polyurethane”, Hanser 1993, page 18, last paragraph to page 19, second paragraph and page 76, fifth paragraph). The PMDI preferably has a viscosity at 25° C. of 100 to 600, particularly preferably 150 to 300 mPa·s. It is also possible to use mixtures of organic isocyanates. PMDI products which are very suitable in the context of the present invention are the products of the LUPRANAT® series of BASF SE, in particular LUPRANAT® M 20 FB of BASF SE.

All known organic metal compounds which accelerate the reaction of isocyanates with compounds comprising hydroxyl groups, in particular with lignocellulose-containing substances, can be used as a catalyst based on an organic metal compound. Examples of such organic metal compounds are organic tin compounds, such as tin(II) salts of organic carboxylic acids, such as tin(II) acetate, tin(II) octanoate, tin(II) ethyl-hexanoate and tin(II) laurate, and the dialkyltin(IV) salts of organic carboxylic acids, such as dibutyltin diacetate, dibutyltin dilaurate, dibutyltin maleate and dioctyltin diacetate, and bismuth carboxylates, such as bismuth(III) neodecanoate, bismuth 2-ethylhexanoate and bismuth octanoate, or alkali metal salts of carboxylic acids, such as potassium acetate or potassium formate, and mixtures of these compounds with one another. Organic tin compounds, in particular tin mercaptides, such as dimethyltin or dioctyltin mercaptides, are preferably used.

The proportion of the catalyst based on an organic metal compound, relative to the total weight of the highly reactive isocyanate component, is preferably from 0.01 to 0.3%, particularly preferably from 0.01 to 0.15% by weight and in particular from 0.01 to 0.08% by weight.

Furthermore, the highly reactive isocyanate component according to the invention also comprises a compound which comprises an aromatic sulfonyl isocyanate group. The sulfonyl isocyanate group must to an aromatic system, for example to a phenyl ring. Preferably, the aromatic system comprises no further isocyanate groups. For example, para-toluenesulfonyl isocyanate may be used as a compound which comprises an aromatic sulfonyl group.

The proportion of the compound which comprises an aromatic sulfonyl isocyanate group, based on the total weight of the highly reactive isocyanate component, is preferably from 0.01 to 2.0% by weight, more preferably from 0.01 to 0.5% by weight, even more preferably from 1 to 5 times, particularly preferably from 2 to 4 times and in particular from 2.5 to 3.5 times, the content of catalyst based on an organic metal compound.

In addition to said substances, the highly reactive isocyanate component may have further compounds which are usually present in an isocyanate component which is used as binder for the production of lignocellulose-containing materials. These may be, for example, customary additives, such as iron compounds, for example iron(III) chloride. If iron(III) chloride is used, the iron content, based on the total weight of the organic isocyanate, is usually from 10 to 100 mg/kg, preferably from 40 to 70 mg/kg. In a further preferred embodiment, the iron content, based on the total weight of the organic isocyanate, is from 10 to 30 mg/kg.

For the production of the lignocellulose-containing materials, lignocellulose-containing substances are with a highly reactive isocyanate component according to the invention and then compressed in a mold at mold temperatures of from 40 to 250° C., preferably from 100 to 240° C. and particularly preferably from 150 to 230° C.

The production of lignocellulose-containing materials according to the invention, preferably those in which the lignocellulose-containing particles are wood particles, is effected in a customary manner, as described in “Taschenbuch der Spanplatten Technik” H.-J. Deppe, K. Ernst, 4th edition, 2000, DRW—Verlag Weinbrenner GmbH & Co., Leinfelden-Echterdingen, chapter 3.5.

The term lignocellulose is known to a person skilled in the art. Important examples of lignocellulose-containing particles are wood parts, such as wood layers, wood strips, woodchips or wood fibers, it being possible for the wood fibers optionally also to originate from wood fiber-containing plants, such as flax, hemp, sunflowers, Jerusalem artichoke or rape.

Wood particles, in particular wood fibers or woodchips, are preferred as lignocellulose-containing substances.

In addition to the highly reactive isocyanate component and the lignocellulose-containing substances, further binders usually used for the production of such materials can be used. These comprise, for example, customary binders prepared on the basis of polycondensates of formaldehyde and phenols, ureas or melamine. Such resins and their preparation are described, for example, in Ullmanns Enzyklopadie der technischen Chemie, 4th, revised and extended edition, Verlag Chemie, 1973, pages 403 to 424, “Aminoplaste”, and Ullmann's Encyclopedia of Industrial Chemistry, Vol. A2, VCH Verlagsgesellschaft, 1985, pages 115 to 141, “Amino Resins”, and in M. Dunky, P. Niemz, Holzwerkstoffe and Leime, Springer 2002, pages 251 to 259 (UF resins) and pages 303 to 313 (MUF and UF with a small amount of melamine).

Furthermore, customary additives may be used. These comprise all additives known to a person skilled in the art, for example waxes, paraffin emulsion, flame-retardant additives, wetting agents, salts, but also inorganic or organic acids and bases, for example mineral acids, such as sulfuric acid, nitric acid, organic sulfonic acids, carboxylic acids, such as formic acid or acetic acid, or inorganic or organic bases, for example sodium hydroxide (aqueous or as such), calcium oxide or calcium carbonate (each aqueous or as such) or ammonia, aqueous or as such. These additives can be added in an amount of from 0 to 20% by weight, preferably from 0 to 5% by weight, in particular from 0 to 1% by weight, based on the dry mass of the lignocellulose-containing substances. Particularly preferably, the proportion of water is minimized. Thus, the proportion of water is preferably less than 2% by weight, particularly preferably less than 1% by weight and in particular less than 0.5% by weight, based in each case on the total weight of all starting materials used for the production of the lignocellulose-containing materials, including residual moisture present in the lignocellulose-containing substances.

Prior to compression, the lignocellulose-containing substances, preferably wood particles, particularly preferably woodchips or wood fibers, are glue-coated with the highly reactive isocyanate component according to the invention. Such so-called glue-coating methods are known for the production of conventional, wood-based materials with customary aminoplast resins and are described, for example, in “Taschenbuch der Spanplatten Technik” H.-J. Deppe, K. Ernst, 4th edition, 2000, DRW—Verlag Weinbrenner GmbH & Co., Leinfelden-Echterdingen, chapter 3.3.

Preferably, the highly reactive isocyanate component and the optionally used further binders and/or customary additives are not mixed before being brought into contact with the lignocellulose-containing substances. All components may be added simultaneously to the lignocellulose-containing substances. In a preferred embodiment, the highly reactive isocyanate component according to the invention is added as the last component to the lignocellulose-containing substances.

The procedure is optionally effected in a plurality of layers. These layers may differ in the type and size of the lignocellulose-containing substances, the amount and the type of the binder used or of the additives used.

The thickness of the multilayer lignocellulose-containing materials according to the invention, preferably of the board-like moldings, varies with the field of use and is as a rule in the range from 0.5 to 300 mm, preferably in the range from 10 to 200 mm, in particular from 12 to 100 mm.

The thickness ratios of the layers of the multilayer lignocellulose-containing moldings according to the invention, preferably of the board-like moldings, are variable. Usually, the outer layers, also referred to as covering layers, individually or in total, are thinner than the layer or layers of the middle layers(s).

The mass an individual covering layer is usually in the range from 5 to 30% by weight, preferably from 10 to 25% by weight, of the total mass of the multilayer lignocellulose-containing molding according to the invention.

The invention furthermore relates to a lignocellulose-containing material obtainable by a process according to the invention. Such a lignocellulose-containing material according to the invention can be used, for example, for the production of articles of furniture and furniture parts, packaging materials, in house building or in vehicles, such as cars, buses, trucks, boats and aircraft. It has a low formaldehyde emission and is particularly stable to hydrolysis.

The highly reactive isocyanate component according to the invention is distinguished by good storability at room temperature and rapid curing in contact with groups reactive towards isocyanate or in contact with moisture, for example at elevated temperature. Thus, the highly reactive isocyanate component according to the invention can also be used for further purposes, for example as a sealant. Such sealants can be used, inter alia, as a moisture-curing sealants, for example in the construction industry. Here, the curing time can also be substantially shortened at room temperature compared with known sealants.

The invention is illustrated below with reference to examples.

### Storage Stability:

The storage stability of a polymer MDI isocyanate component having a viscosity of 260 mPa·s at 20° C. and an iron content of 25 mg/kg and a content of 0.04% by weight of the tin catalyst Fomrez®.UL32 from Witco is tested. For this purpose the polymer MDI isocyanate component is stored without further additives at 25° C. (comparison) and with 0.12% by weight, based on the total weight of the mixture, of para-toluenesulfonyl isocyanate at 25° C. (example 1) and at 50° C. (example 2). The viscosity of the mixtures in mPa·s as a function of the duration of storage is shown in table 1 and FIG. 1.

TABLE 1

| | Comparison | Example 1 (25° C.) | Example 2 (50° C.) |
|---|---|---|---|
| 0 days | 268 mPa · s | 268 mPa · s | 268 mPa · s |
| 7 days | 276 mPa · s | 267 mPa · s | 262 mPa · s |
| 11 days | 280 mPa · s | 266 mPa · s | 265 mPa · s |
| 16 days | 296 mPa · s | 267 mPa · s | 266 mPa · s |
| 22 days | 322 mPa · s | 270 mPa · s | 267 mPa · s |
| 29 days | 385 mPa · s | 270 mPa · s | 285 mPa · s |
| 36 days | 432 mPa · s | 270 mPa · s | 292 mPa · s |
| 40 days | — | 272 mPa · s | 297 mPa · s |
| 60 days | — | 270 mPa · s | 305 mPa · s |
| 80 days | — | 268 mPa · s | 310 mPa · s |
| 100 days | — | 268 mPa · s | 315 mPa · s |

Table 1 shows that the viscosity of the isocyanate component without para-toluenesulfonyl isocyanate increases within a few days even at 25° C. On the other hand, the viscosity of the isocyanate component with para-toluenesulfonyl isocyanate, which was stored at 25° C., is still as the same as the starting viscosity even after storage for 100 days, and the viscosity increase of the isocyanate component with para-toluenesulfonyl isocyanate, stored at 50° C., is also substantially slowed down compared with the comparative example at 25° C.

The reactivity of the isocyanate component as a function of the catalyst concentration is shown in table 2. The tests were carried out on the basis of the standard EN 319. OSB (Oriented Strand Boards) wood fibers were mixed with 4% of isocyanate mixture and pressed at a press plate temperature of 220 degrees with different pressing factors from 7 to 9 sec/mm (staggered in 0.5 sec/mm steps). Thereafter, test specimens measuring 50×50×14 mm were cut out and were stored for 7 days under standard climatic conditions. The transverse tensile strength according to EN 319 was determined on these test specimens. The composition of the isocyanate component in comparative experiment 2 corresponded to that from comparison 1, no catalyst having been used. The composition of the isocyanate component in example 2 corresponded to example 1, 0.06% by weight of catalyst having been used instead of 0.04% by weight.

TABLE 2

| | | |
|---|---|---|
| Pressing time in s/mm | | |
| thickness | Comparison 2 | Example 3 |

| | | | |
|---|---|---|---|
| 7 | 0.05 | N/mm² | 0.75 N/mm² |
| 7.5 | 0.3 | N/mm² | 0.75 N/mm² |
| 8 | 0.55 | N/mm² | 0.78 N/mm² |
| 8.5 | 0.8 | N/mm² | 0.80 N/mm² |
| 9 | 1.0 | N/mm² | 0.80 N/mm² |

Table 2 shows that a high transverse tensile strength is achieved with the use of example 1 after pressing times of only 7 seconds per mm thickness, while corresponding values of the transverse tensile strength are achieved for comparison example 2 only after 8.5 seconds/mm.

1. A reactive isocyanate component, comprising:
(a) an organic isocyanate comprising at last two isocyanate groups;
(b) a catalyst comprising an organic metal compound; and
(c) a compound comprising an aromatic sulfonyl isocyanate group.

2. The reactive isocyanate component of claim 1, wherein the compound (c) is para-toluenesulfonyl isocyanate.

3. The reactive isocyanate component of claim 1, wherein the catalyst (b) is an organic tin compound.

4. The reactive isocyanate component of claim 1, wherein the organic isocyanate (a) is an isocyanate comprising monomeric and polymeric methylenediphenyl diisocyanate.

5. A process for producing a lignocellulose-comprising material, the process comprising:
mixing a lignocellulose-comprising substance with the reactive isocyanate component of claim 1, to obtain an intermediate mixture; and then
compressing the intermediate mixture in a mold at a mold temperature in a range from 40 to 250° C.

6. The process of claim 5, wherein during the mixing, the lignocellulose-comprising substance is mixed with the reactive isocyanate component and a binder comprising a formaldehyde resin.

7. A lignocellulose-containing material obtained by the process of claim 5.

8. The lignocellulose-comprising material of claim 7, the form of an article of furniture, a furniture part, a packaging material, a house building material or a vehicle material.

9. A sealant, comprising the reactive isocyanate component of claims 1.

10. The reactive isocyanate component of claim 3, wherein the tin catalyst (b) is a tin mercaptide.

11. The reactive isocyanate component of claim 10, wherein the catalyst (b) is dimethyltin mercaptide.

12. The reactive isocyanate component of claim 10, wherein the catalyst (b) is dioctyltin mercaptide.

13. The reactive isocyanate component of claim 1, wherein a content of the catalyst (b) in the reactive isocyanate component is from 0.01 to 0.3% by weight, relative to a total weight of the reactive isocyanate component.

14. The reactive isocyanate component of claim 1, wherein a content of the catalyst (b) in the reactive isocyanate component is from 0.01 to 0.15% by weight, relative to a total weight of the reactive isocyanate component.

15. The reactive isocyanate component of claim 1, wherein a content of the catalyst (b) in the reactive isocyanate component is from 0.01 to 0.08% by weight, relative to a total weight of the reactive isocyanate component.

16. The reactive isocyanate component of claim 1, wherein a content of the compound (c) in the reactive isocyanate component is from 0.01 to 2.0% by weight, relative to a total weight of the reactive isocyanate component.

17. The reactive isocyanate component of claim 1, wherein a content of the compound (c) in the reactive isocyanate component is from 0.01 to 0.5% by weight, relative to a total weight of the reactive isocyanate component.

18. The isocyanate component of claim 1, wherein a content of the compound (c) in the isocyanate component is from 1 to 5 times a content of the catalyst (b) in the isocyanate component.

19. The isocyanate component of claim 1, wherein a content of the compound (c) in the isocyanate component is from 2 to 4 times a content of the catalyst (b) in the isocyanate component.

20. The isocyanate component of claim 1, wherein a content of the compound (c) in the isocyanate component is from 2.5 to 3.5 times a content of the catalyst (b) in the isocyanate component.
